(19) United States
(12) Patent Application Publication
(10) Pub. No.: US 2013/0167177 A1
(43) Pub. Date: Jun. 27, 2013

(54) METHOD OF DISPLAYING TV PROGRAM PROGRESS TIME AND DEVICE THEREOF

(71) Applicant: SAMSUNG ELECTRONICS CO., LTD., Suwon-City (KR)

(72) Inventor: Hyoung-Joo LEE, Seoul (KR)

(73) Assignee: SAMSUNG ELECTRONICS CO., LTD., Suwon-City (JP)

(21) Appl. No.: 13/772,548

(22) Filed: Feb. 21, 2013

Related U.S. Application Data
(63) Continuation of application No. 09/055,712, filed on Apr. 7, 1998.

(30) Foreign Application Priority Data
Jun. 24, 1997 (KR) 1997-26688

(51) Int. Cl. H04N 21/435

(52) U.S. Cl. CPC H04N 21/435
USPC 725/40

(57) ABSTRACT

A method of displaying program progress time in a TV receiver which receives and processes program guide information containing a program schedule, includes storing the program guide information, and displaying time information about a relevant program on the picture tube when the user issues a command requesting the displaying of a program progress time with respect to a currently viewed program.

### CROSS-REFERENCE TO RELATED APPLICATIONS

This application is a U.S. continuation application filed under 37 CFR 1.53(b) claiming priority benefit of U.S. Ser. No. 09/055,712 filed in the United States on Apr. 7, 1998, which claims earlier priority benefit to Korean Patent Application No. 1997-26688 filed with the Korean Intellectual Property Office on Jun. 24, 1997, the disclosures of which are incorporated herein by reference.

### BACKGROUND OF THE INVENTION

1. Field of the Invention

The present invention relates to a TV receiver, and more particularly, to a method for displaying a TV program progress time and a device thereof.

2. Description of the Related Art

Usually, a user can check a TV program progress time, i.e., beginning/terminating time, and a televised elapsed time, by referring to a program schedule guide printed in information media like newspapers and magazines.

In the next generation digital TV broadcasting system capable of providing users with program guide information, a user can instruct a TV set to display the program schedule information according to the program guide to check the progress time of the currently viewed program. When the TV receiver displays the program schedule information in response to the above instruction, the user can determine the progress time of the currently viewed program on his own from the program schedule information.

It is cumbersome for the user to refer to newspapers to check the progress time of the currently viewed program according to the conventional method. Further, in the device for displaying the program schedule information as in the next generation digital TV receiver, it is also inconvenient for the user to instruct the TV set during viewing to display the program schedule information. Such a display of the program schedule information overlaps with the program screen, which is another problem causing interruption of the user's viewing. It is also troublesome for the user to search the program schedule information for the currently viewed program to check the program progress time.

### SUMMARY OF THE INVENTION

Accordingly, it is an object of the present invention to provide a method and device capable of directly displaying the program progress time information about the currently viewed program on the screen immediately upon request.

Additional objects and advantages of the invention will be set forth in part in the description which follows and, in part, will be obvious from the description, or may be learned by practice of the invention.

According to the present invention, a method of displaying a program progress time in a TV receiver which receives and processes program guide information containing a program schedule, includes the steps of storing the program guide information, and displaying time information about the relevant program on a picture tube when the user issues a command requesting display of the program progress time with respect to the currently viewed program.

### BRIEF DESCRIPTION OF THE DRAWINGS

The preferred embodiment of the present invention will now be described more specifically with reference to the drawings attached only by way of example.

FIG. 1 a block diagram illustrating a High Definition Television (HDTV) receiver according to an embodiment of the present invention;

FIG. 2 is a flow chart illustrating a display of program progress time according to the embodiment of the present invention;

FIG. 3 is a descriptive diagram of a display screen illustrating a setup menu of the program progress time information according to the embodiment of the present invention; and

FIGS. 4 and 5 are descriptive diagrams illustrating the program progress time information displayed on the screen of a picture tube according to the embodiment of the present invention.

### DETAILED DESCRIPTION OF PREFERRED EMBODIMENTS

Reference will now made in detail to the present preferred embodiments of the present invention, examples of which are illustrated in the accompanying drawings, wherein like reference numerals refer to the like elements throughout. The embodiments are described below in order to explain the present invention by referring to the figures.

In order that the present invention is implemented, a broadcast station broadcasts program schedule information, whereby the above TV set receives and stores the program guide information including the program schedule, and thereby displays the program progress time on a TV screen according to the embodiment of the present invention.

As mentioned above, TV broadcast stations broadcast program guide information. Besides, the next generation digital TV broadcasting, like the HDTV (high definition television) of the U.S.A., provides users with the program guide information. Particularly, the United States Advanced Television System Committee (ATSC) standard stipulates that the program guide information shall be included in the electronic program guide (EPG).

When the present invention is applied to the next generation digital TV broadcasting, the broadcast station doesn't need to separately broadcast program guide information.

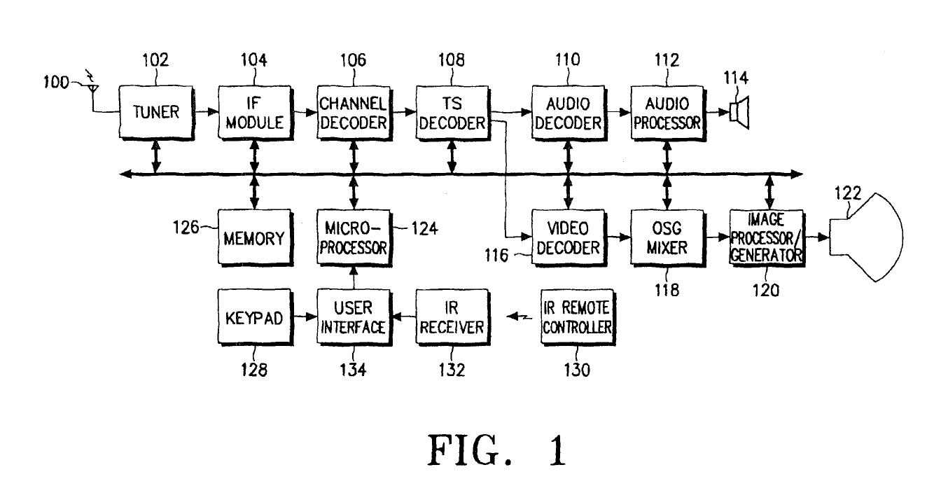

An example of the application of the present invention to the above HDTV is explained in the following. Referring to FIG. 1, a tuner 102 selects an RF channel desired by a user from the input signals received through an antenna 100 under the control of a microprocessor 124. The tuner 102 outputs an IF (intermediate frequency) signal, which is converted into a baseband signal by an IF module 104 so as to be delivered to a channel decoder 106. The channel decoder 106 converts the baseband signal to a channel signal to reconstruct a transport stream (TS). The TS decoder 108 separates the above reconstructed TS into audio and video streams and auxiliary data.

The above audio stream is applied to an audio decoder 110, whereby the audio data are reconstructed. An audio processor 112 processes and converts the audio data from the audio decoder 110 into an audio signal, and the audio signal is output through speaker 114 as an audible sound.

The video stream is applied to a video decoder 116, whereby video data are reconstructed, then applied to an OSG (on screen graphic) mixer 118 so as to be mixed with OSG data under the control of microprocessor 124, and then delivered to an image processor/generator 120 which converts the video data into a video signal to be applied to a picture tube 122.

The microprocessor 124 performs operations commanded by user instructions input from a keypad 128 or an IR remote controller 130 through a user interface 134 in accordance with a program stored in a memory 126. User instructions input from the IR remote controller 130 are delivered in the form of an IR signal to an IR receiver 132 so as to be further supplied to the user interface 134. The microprocessor 124 receives auxiliary data containing EPG information from the TS decoder 108.

The memory 126 includes a ROM (Read Only Memory) for storing the program of the microprocessor 124, a RAM (Random Access Memory) for temporarily storing data resulting from the program execution of the microprocessor 124, and an EEPROM (Electrically Erasable and Programmable ROM) for storing various reference data.

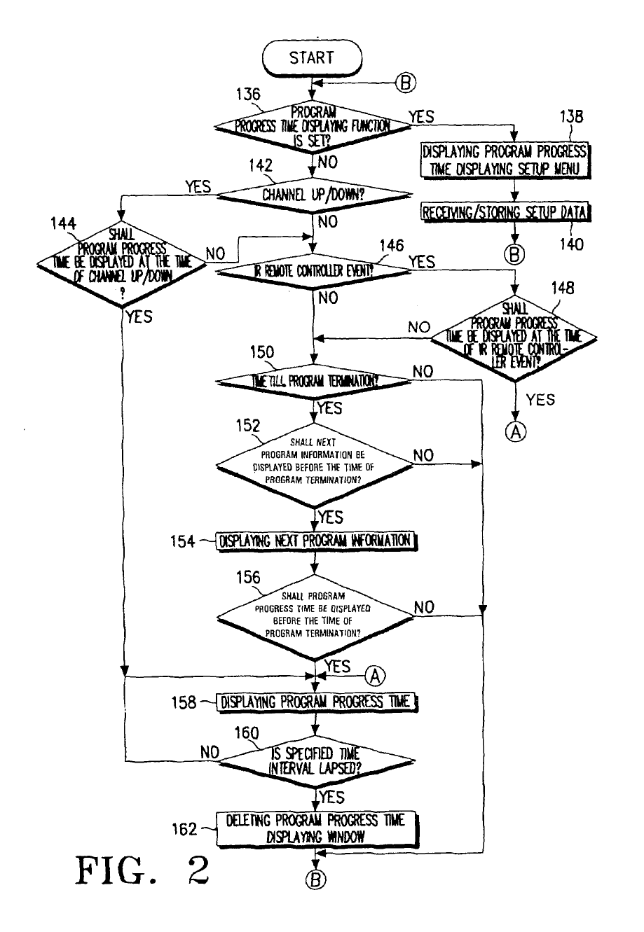

Referring to FIG. 2, the embodiment of the present invention is described in detail as follows. In step 136, the microprocessor 124 checks whether a user instruction for setup of a program progress time displaying function is received from the keypad 128 or the IR remote controller 130. When the user sets the program progress time displaying function, the microprocessor 124 proceeds to step 138, and otherwise proceeds to step 142. In step 138, the microprocessor 124 generates OSG data for displaying a setup menu of the program progress time displaying function and delivers the OSG data to the OSG mixer 118. The OSG mixer 118 mixes the OSG data from the microprocessor 124 and the video data from the video decoder 116, thereby delivering the resulting data to the image processor/generator 120 to display the setup menu of the program progress displaying function on the screen of picture tube 122.

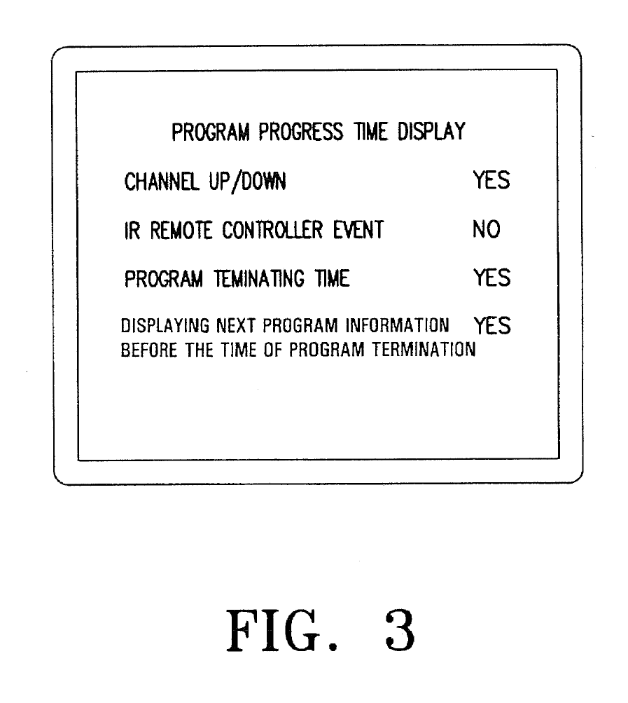

Referring to FIG. 3 illustrating the setup menu of a program progress time displaying window, the menu is presented on the left side of the window, and the selection state on the right side. That is, the menu offers menu selection options for displaying program information including “when changing channel up/down,” “in IR remote controller events,” “when terminating programs,” and “next program information when terminating programs.”

The user's selection state is manipulated by selecting “YES” or “NO” by using the keypad 128 or the IR remote controller 130, whereby the user selects “YES” for displaying the program progress time with respect to respective menu options, and otherwise selects “NO.” Besides, the user selects “YES” for displaying the next program information before terminating a current program, and otherwise selects “NO.”

In step 140, the microprocessor 124 receives and stores the setup data for displaying program progress time information, and then returns to step 136. In step 142, the microprocessor 124 checks whether the user issues the channel up/down command using the keypad 128 or the IR remote controller 130, thereby performing step 144 when the channel up/down command is issued, and otherwise performing step 146.

In step 144, the microprocessor 124 reads out the above setup data, thereby checking whether the setup menu is set so as to display the program progress time when the channel is changed up or down, whereupon the microprocessor 124 proceeds to step 158 if the setup menu is set so as to display the program progress time when the channel is changed up or down, thereby displaying the program progress time.

The microprocessor 124 produces OSG data for displaying the program progress time and delivers the OSG data to the OSG mixer 118. The OSG mixer 118 mixes the OSG data from microprocessor 124 and the video data from the video decoder 116, and delivers the resulting data to the image processor/generator 120 for display on the picture tube 122.

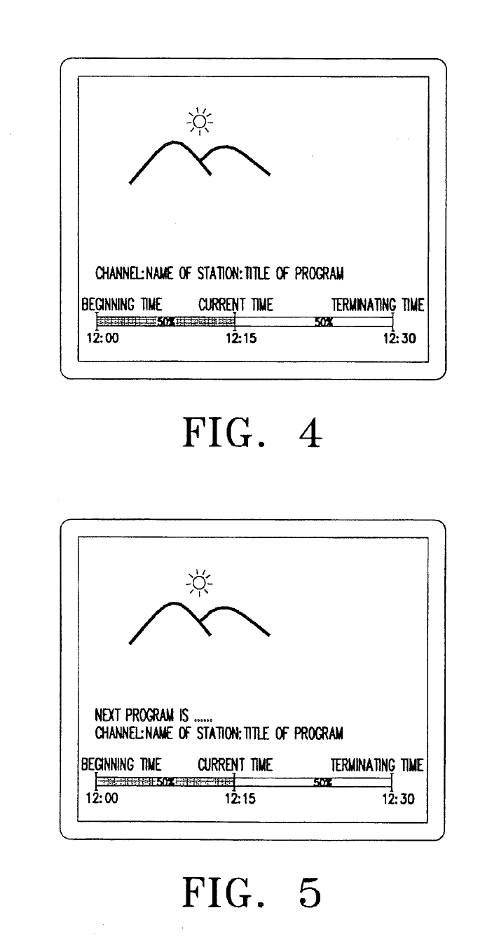

Referring to FIG. 4, illustrating the program progress time display based on the data produced by mixing the video data and the OSG data using the OSG mixer 118, the On-Screen-Graphic is described in detail as follows. First, the microprocessor 124 reads out the relevant program schedule information from the program guide information and then checks the beginning/terminating time of the program, thereby displaying the beginning and terminating time, and the current program progress time showing the elapsed time of the program.

As shown in FIG. 4, a bar is displayed, wherein one end of the bar represents the beginning time and the other end thereof represents the terminating time, and the entire length thereof represents the entire broadcasting time of the program. When the program progress time is displayed, the current time is detected and indicated on the bar, whereby the portion from the beginning time to the current time is called the progress time portion which is displayed in a different color with respect to the remaining portion.

The progress time portion is indicated percentagewise with respect to the entire length of the bar, i.e., the entire broadcasting time. And the remaining portion from the current time to the terminating time is called the remaining time portion which is indicated percentagewise with respect to the entire bar length. Furthermore, the program number, the name of the broadcast station, and the title of the program are displayed above the time bar, and this information including the time bar cumulatively are called the program progress time information.

After displaying the program progress time information, the microprocessor 124 performs steps 160-162, determining whether a specified time interval has elapsed in step 160, and closing the display window of the program progress time information after the specified time interval has elapsed in step 162. The microprocessor then returns to step 136.

In step 144, if the setup menu is set so as not to display the program progress time when the channel is changed up or down, the microprocessor 124 proceeds to step 146. In step 146, the microprocessor 124 checks whether an event of the IR remote controller 130 exists, and if so, proceeds to step 148, and otherwise to step 150. In step 148, the microprocessor 124 checks the setup data for whether the program progress time shall be displayed when the event of the IR remote controller 130 exists, and if so, performs the previously described steps of 158-162, and otherwise proceeds to step 150.

In step 150, the microprocessor 124 checks whether the time from the current time of the program to the terminating time thereof is equal to a preset time. In other words, the microprocessor 124 determines whether the remaining time portion of the currently viewed program is less than the preset time. The preset time is set at the time of manufacture, or can be set by the user. Thus, when the time from the current time of the program to the terminating time thereof is equal to the preset time, the microprocessor 124 proceeds to step 152, and otherwise returns to step 136.

In step 152, the microprocessor 124 checks the setup data for whether the next program information shall be displayed before the current program is terminated, and if so, proceeds to step 154, and otherwise returns to step 136.

In step 154, the microprocessor 124 produces OSG data for displaying the next program information and delivers the OSG data to the OSG mixer 118. The OSG mixer 118 mixes the OSG data from the microprocessor 124 and the video data from the video decoder 116. The OSG mixer 118 delivers the resulting data to the image processor/generator 120 for display on the picture tube 122.

Upon generation of the OSG data for displaying the next program information, the microprocessor 124 proceeds to step 156 to check whether the setup menu is set so as to display the program progress time before the current program is terminated, and if so, performs the previously described steps 158-162, and otherwise returns to step 136.

When the setup menu is set to display the next program information and the program progress time information, the microprocessor 124 displays all the information as shown in FIG. 5. The OSG for the next program information is displayed above the program progress time bar.

As described above, the program progress time is displayed when the time from the current time of the program to the terminating time thereof is equal to the preset time and the program process time is set to be displayed. Besides, at this time, the next program progress information is displayed when the next program is set to be displayed.

What is claimed is:

1. An apparatus for displaying a program progress time on a display of a TV receiver which receives and processes program guide information, the apparatus comprising:
a memory to store the program guide information including a program schedule which corresponds to an object read out by a processor in the receiver; and
the processor configured to:
establish a command of the TV receiver which is commonly usable by a user as a setup to display time information about a current program on the display;
display the time information about the current program on the display when the user issues the setup; and
display next program information when the remaining program time reaches to a preset time, thereby allowing possible inconsistency between a time information of the current program and a time information of a next program to be seen, by providing the time information of the current program along with the time information of the next program based on the setup by an interactive program guide while the current program is on.

2. The apparatus of claim 1, wherein the time information further comprises a percentage of the program progress time as compared with a total program broadcasting time calculated by subtracting the beginning time from the program terminating time.

3. The apparatus of claim 1, wherein the time information further comprises a percentage of the remaining program time as compared with the total program broadcasting time.

4. The apparatus of claim 1, wherein the command of the TV receiver is a command for a channel up/down.

5. The apparatus of claim 1, wherein the command of the TV receiver is a command for a remote controller event.

6. An apparatus of displaying a program progress time of a current program of a television (TV) receiver, the apparatus comprising:
a tuner to receive program guide information including a program schedule which corresponds to an object read out by a processor in the receiver; and
the processor configured to:
display the program progress time of the current program in response to a setup established by a command from a user to perform a function; and
display next program information of a next program on a same channel as the current program at the preset time prior to the program termination of the current program, thereby allowing possible inconsistency between a time information of the current program and a time information of the next program to be seen, by providing the time information of the current program along with the time information of the next program based on the setup by an interactive program guide while the current program is on.

7. The apparatus of claim 6, wherein the program progress time includes a program beginning time, a current time, and a program termination time of the current program.

8. The apparatus of claim 6, wherein the program progress time further includes a channel number, a name of a broadcast station and a title of the current program.

9. The apparatus of claim 6, wherein the processor is configured to display the beginning time at a start of a display bar, the program termination time at end of the display bar, and the current time at a position of the display bar corresponding to a percentage of time elapsed versus a total time of the current program.

10. The apparatus of claim 9, wherein the processor is configured to further display a first percentage number of the time elapsed and a second percentage number of a time remaining versus the total time of the current program.

11. The apparatus of claim 6, wherein the command is to display the program progress time automatically at a preset time prior to a program termination of the current program.

12. An apparatus for providing a time information of a program in a digital television receiver, the apparatus comprising;
a decoder to decode a baseband signal obtained from a broadcast signal to reconstruct a transport stream and divide the transport stream into audio, video and auxiliary data, the auxiliary data comprising program guide information; and
a processor configured to:
extract an object containing program schedule information from the program guide information, wherein the object is populated with the program schedule information and read out by the processor in the receiver, so that a user knows what programs are on over time; and
allow possible inconsistency between a time information of a current program and a time information of a next program to be seen, by providing the time information of the current program along with the time information of the next program based on a setup by an interactive program guide while the current program is on.
